(19) United States
(12) Patent Application Publication
(10) Pub. No.: US 2013/0237112 A1
(43) Pub. Date: Sep. 12, 2013

(54) ANIONIC POLYMER ION-EXCHANGE MATERIAL AND METHOD FOR PRODUCING THE SAME

(71) Applicant: JAPAN ATOMIC ENERGY AGENCY, Ibaraki (JP)

(72) Inventors: Jinhua CHEN, Gunma (JP); Masaharu ASANO, Gunma (JP); Yasunari MAEKAWA, Gunma (JP)

(73) Assignee: JAPAN ATOMIC ENERGY AGENCY, Ibaraki (JP)

(21) Appl. No.: 13/778,214

(22) Filed: Feb. 27, 2013

(30) Foreign Application Priority Data
Mar. 9, 2012 (JP) 2012-053408

(51) Int. Cl. B01J 41/12

(52) U.S. Cl. CPC B01J 41/125
USPC 442/301; 521/30; 521/27; 428/398; 442/414

(57) ABSTRACT

With respect to the anionic polymer ion-exchange material used in an alkaline fuel cell, an electrodialysis apparatus, water treatment industry, catalyst industry, and the like, there are provided an anionic polymer ion-exchange material having both excellent ionic conductivity and excellent mechanical strength, as compared to the materials conventionally used, and a method for producing the same. An anionic polymer ion-exchange material having a polymer base material mainly made of an amide resin having both an aromatic structure and an aliphatic chain in the principal chain thereof, wherein the polymer base material has an anionic monomer graft-polymerized on the aliphatic chain in the principal chain of the amide resin, wherein the anionic monomer has an aromatic structure and a quaternary ammonium structure.

### TECHNICAL FIELD

The present invention relates to an anionic polymer ion-exchange material having both high mechanical strength and high ionic conductivity and a method for producing the same.

### BACKGROUND ART

Anionic polymer ion-exchange materials in the form of a sheet are widely used in alkaline fuel cells, electrodialysis systems, and the like. The anionic polymer ion-exchange materials in a sheet form used in these devices are required to have both high mechanical strength and high ionic conductivity.

Further, utilizing the properties of ion-exchange resin, the anionic polymer ion-exchange materials in a fibrous form are used in a wide variety of fields, such as water treatment, ultrapure water production, purification and separation of chemical substances, solid catalysts, water absorbers, and the like. Furthermore, the anionic polymer ion-exchange materials are also used as materials for a special filter and the like.

These fibrous materials are required to have not only high mechanical strength but also high ion-exchange capacity. The term “ion-exchange capacity” indicates a molar amount of the ammonium contained in one gram of an anionic polymer ion-exchange material.

Generally, in a polymer ion-exchange material, the higher the ion-exchange capacity, the higher the ionic conductivity. However, the polymer ion-exchange material having a high ion-exchange capacity or ionic conductivity is considerably low in mechanical strength. In this connection, it is noted that the high mechanical strength of a polymer ion-exchange material is a property contrary to the high ionic conductivity and high ion-exchange capacity of the polymer ion-exchange material, and it is extremely difficult to achieve a polymer ion-exchange material having all these excellent properties.

Conventionally, various studies have been made on the method for producing an anionic polymer ion-exchange material. However, the above-mentioned problems have not been practically solved by any methods conventionally studied, and other practical problems have been found to arise.

For example, patent document 1(JP-A-2005-344263) discloses a method for producing an anionic polymer ion-exchange membrane, which comprises applying a monomer having a functional group capable of introducing an anionic group to woven fabric made of polyvinyl chloride or the like and subjecting the applied monomer to chemical polymerization and then, effecting an ammonium quaternization reaction of the introduced functional group to introduce an anionic group, thereby producing an anionic polymer ion-exchange membrane. However, the anionic polymer ion-exchange membrane produced by this method has a disadvantage in that the polymer chain having ion-exchange properties and the polyvinyl chloride base material have no chemical bonding between them and hence the polymer chain having ion-exchange properties is likely to flow out of the ion-exchange membrane being used, so that the ionic conductivity of the ion-exchange membrane is reduced. Further, polyvinyl chloride as a base material is poor in properties, such as a heat resistance and a mechanical strength, and therefore the produced anionic polymer ion-exchange membrane has a reduced use-life.

Patent document 2(JP-A-2000-331693) proposes a method for producing an anionic polymer ion-exchange material by a radiation graft polymerization method. In this method, chloromethyl styrene is graft-polymerized on a polymer base material, followed by an ammonium quaternization reaction, to produce an anionic polymer ion-exchange material. This method has a complicated production process including a quaternization step, and hence poses problems of the high production cost and the control of environment for the production line.

For solving the problems, direct grafting of an anionic monomer having an ammonium structure which needs no quaternization step, e.g., vinylbenzyltrimethyl ammonium chloride, on a polymer base material is considered. However, the anionic monomer has high polarity so that the affinity of the anionic monomer with a general polymer base material having excellent durability and excellent processability is low, and it is not easy to graft such an anionic monomer on the polymer base material.

In the method of patent document 3 (JP-A-1994-49236) using radiation graft polymerization, a highly polymerizable hydrophilic acrylic monomer as well as the above-mentioned anionic monomer are graft-copolymerized to obtain an anionic polymer ion-exchange material having the anionic monomer introduced thereinto. However, a large amount of the hydrophilic acrylic monomer is introduced by graft copolymerization into the polymer ion-exchange material, and therefore problems remain unsolved in that the obtained polymer ion-exchange material has an unsatisfactory mechanical strength and in that the ionic conductivity and ion-exchange capacity cannot be increased.

With respect to the method for producing a polymer ion-exchange material by radiation graft polymerization, a technique for improving the graft reaction in efficiency is proposed in patent document 4 (JP-A-2001-348439), in which a polymer base material comprising a polytetrafluoroethylene membrane is irradiated with radiation in an atmosphere under conditions such that the temperature is in the range of from 300 to 365° C. and the oxygen partial pressure is 10 Torr or less to modify the surface layer of the polymer base material into long-chain branched polytetrafluoroethylene, and then a monomer is selectively grafted on the end of the branched chain to introduce a sulfonic acid group exclusively into the graft side chain, increasing the graft ratio while maintaining the mechanical strength of the polytetrafluoroethylene membrane.

This technique, however, can be applied only to the polymer base material using a fluororesin, such as polytetrafluoroethylene, and has many restrictions of the selection of the material for a base material and the form of ion-exchange material.

A porous membrane made of a fluororesin, such as polytetrafluoroethylene, has high chemical stability, and therefore is widely used as a polymer base material for a graft chain-introduced ion-exchange material. However, the fluororesin porous membrane is poor in mechanical strength and the like, and hence has many restrictions of the form of usage, and therefore, as seen in patent document 5 (JP-A-11-300171), an improvement is being made on the fluororesin porous membrane, for example, fully aromatic polyamide woven fabric or nonwoven fabric as a reinforcement and the fluororesin porous membrane are used in combination. In this case, there are problems, for example, in that the ratio of the ion-exchange group in the whole ion-exchange material is small and thus the graft ratio is reduced, and in that a multi-stage step for fabricating the anion-exchange material is required.

### DISCLOSURE OF INVENTION

### Problems that the Invention is to Solve

The present invention relates to an anionic polymer ion-exchange material used in an alkaline fuel cell, an electrodialysis apparatus, water treatment industry, catalyst industry, a pure water production system, and the like, specifically, an anionic polymer ion-exchange material which has a large degree of freedom with respect to the selection of the material for a base material and the selection of the form of the ion-exchange material, and which can achieve both high ionic conductivity and high mechanical strength, and a method for producing the same.

### Means for Solving the Problems

The present inventors have paid attention to the high mechanical strength and excellent processability of an aromatic polymer material, and have made extensive and intensive studies with a view toward developing an anionic polymer ion-exchange material having an aromatic structure. As a result, they have made a synthesis by subjecting a polymer base material mainly made of an amide resin having both an aromatic structure and an aliphatic chain in the principal chain thereof to radiation graft polymerization in a polar solution of an anionic monomer having an aromatic structure and a quaternary ammonium structure and have succeeded in synthesizing an anionic polymer ion-exchange material having a graft chain of the anionic monomer introduced into the polymer base material at a high ratio, and the invention has been completed.

Specifically, the invention has the following characteristic features.

(1) An anionic polymer ion-exchange material comprising a polymer base material mainly made of an amide resin having both an aromatic structure and an aliphatic chain in the principal chain thereof, the polymer base material having an anionic monomer graft-polymerized on the aliphatic chain in the principal chain of the amide resin, the anionic monomer having an aromatic structure and a quaternary ammonium structure.

(2) The anionic polymer ion-exchange material according to item (1) above, wherein the graft polymerization is radiation graft polymerization.

(3) The anionic polymer ion-exchange material according to item (1) or (2) above, wherein the polymer base material mainly made of the amide resin comprises an amide polymer or amide copolymer having both an aromatic structure and an aliphatic chain in the principal chain thereof, or a composite material mainly made of the polymer.

(4) The anionic polymer ion-exchange material according to any one of items (1) to (3) above, wherein the anionic monomer does not contain other monomers except a crosslinking agent.

(5) The anionic polymer ion-exchange material according to any one of items (1) to (4) above, wherein the polymer base material is a fibrous base material which is fibers, a yarn, hollow fibers, a rope, or a composite material thereof, and the anionic polymer ion-exchange material is a fibrous material.

(6) The anionic polymer ion-exchange material according to any one of items (1) to (4) above, wherein the polymer base material is a sheet-form base material which is a film, a membrane, woven fabric, nonwoven fabric, or a laminated material thereof, and the anionic polymer ion-exchange material is a sheet-form material.

(7) The anionic polymer ion-exchange material according to any one of items (1) to (4) above, wherein the polymer base material is a three-dimensional shaped base material which is pellets, a column, a porous material, a foamed material, or a composite material thereof, and the anionic polymer ion-exchange material is a three-dimensional shaped material.

(8) The anionic polymer ion-exchange material according to any one of items (1) to (7) above, wherein the amount of the graft polymer chain of the anionic monomer is 20 to 100% by weight, based on the weight of the polymer base material.

(9) The anionic polymer ion-exchange material according to any one of items (1) to (8) above, which has a tensile strength of 25 to 80 MPa.

(10) The anionic polymer ion-exchange material according to any one of items (1) to (9) above, which has an ion-exchange capacity of 0.8 to 3.0 mmol/g, and has a volume electric conductivity of 0.01 to 0.20 S/cm as measured with respect to the material in the state of being saturated with water at room temperature.

(11) The anionic polymer ion-exchange material according to any one of items (1) to (10) above, wherein the amide resin has a structure represented by the following chemical formula (1):

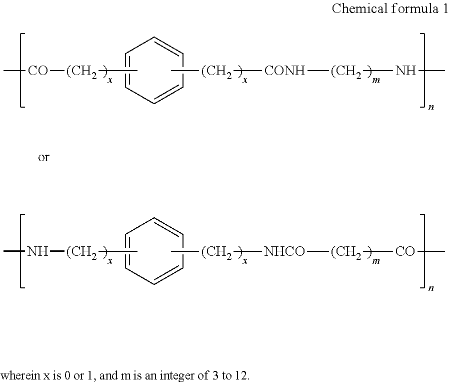

(12) A method for producing an anionic polymer ion-exchange material, comprising subjecting to graft polymerization a polymer base material mainly made of an amide resin having both an aromatic structure and an aliphatic chain in the principal chain thereof so that an anionic monomer having an aromatic structure and a quaternary ammonium structure is grafted on the aliphatic chain in the principal chain of the amide resin.

(13) The method according to item (12) above, which comprises the steps of:

(a) placing a polymer base material mainly made of an amide resin having both an aromatic structure and an aliphatic chain in the principal chain thereof in an apparatus for isolating the inside from an external environment to maintain an oxygen-free atmosphere and allowing the polymer base material to stay in the apparatus for a predetermined period of time or more so that the polymer base material contains no oxygen;

(b) irradiating the polymer base material, which is mainly made of an amide resin having both an aromatic structure and an aliphatic chain in the principal chain thereof and which contains no oxygen, with radiation in an oxygen-free atmosphere;

(c) dissolving an anionic monomer having an aromatic structure and a quaternary ammonium structure in a polar solvent deaerated for oxygen gas in an oxygen-free atmosphere;

(d) conducting a graft polymerization in which the polymer base material irradiated with radiation is immersed in the solution of the anionic monomer in the oxygen-free atmosphere; and

(e) maintaining the irradiated polymer base material in a state of being immersed in the solution of the anionic monomer in the oxygen-free atmosphere to effect the graft polymerization.

(14) The method according to item (13) above, wherein the oxygen-free atmosphere is an atmosphere purged with argon gas, an atmosphere purged with nitrogen gas, or the inside of a vacuum vessel.

(15) The method according to item (13) or (14) above, wherein the radiation for irradiation is a gamma-ray or an electron beam.

(16) The method according to any one of items (12) to (15) above, wherein the polymer base material is a fibrous base material which is fibers, a yarn, hollow fibers, a rope, or a composite material thereof, and the anionic polymer ion-exchange material is a fibrous material.

(17) The method according to any one of items (12) to (15) above, wherein the polymer base material is a sheet-form base material which is a film, a membrane, woven fabric, nonwoven fabric, or a laminated material thereof, and the anionic polymer ion-exchange material is a sheet-form material.

(18) The method according to any one of items (12) to (15) above, wherein the polymer base material is a three-dimensional shaped base material which is pellets, a column, a porous material, a foamed material, or a composite material thereof, and the anionic polymer ion-exchange material is a three-dimensional shaped material.

### Advantage of the Invention

In the invention, there can be obtained an anionic polymer ion-exchange material the mechanical strength of which is increased while increasing the anionic conductivity or without lowering the anionic conductivity.

Further, by the method of the invention, an anionic polymer ion-exchange material in various shapes and forms having high strength and high ionic conduction property can be provided with high efficiency at a low cost, and therefore the produced anionic polymer ion-exchange material enables the practical use of alkaline fuel cells and the improvement of performance of electrodialysis, and can substitute for many of the anionic polymer ion-exchange materials currently used and can be applied to a wide variety of fields, such as water treatment, pure water production, separation and purification of chemical substances, and solid catalysts.

### MODE FOR CARRYING OUT THE INVENTION

Hereinbelow, the present invention will be described in detail.

### Anionic Polymer Ion-Exchange Material

The anionic polymer ion-exchange material of the invention comprises a polymer material mainly made of an amide resin having both an aromatic structure and an aliphatic chain in the principal chain thereof as a base material, and has graft-polymerized on the polymer material an anionic monomer having an aromatic structure and a quaternary ammonium structure, and has, for example, the following features.

The first feature is that a polymer base material mainly made of a semi-aromatic amide resin is used wherein the semi-aromatic amide resin has in the principal chain thereof an aromatic structure and an amide structure relating to the high modulus of elasticity and high strength, and has in the principal chain thereof an aliphatic chain relating to the flexibility and processability, and is widely used as an engineering plastic having high performance and good balance of various properties. That is, the obtained anionic polymer ion-exchange material has high strength and excellent shapability so that it can be processed into various shapes and forms, such as the form of a fiber, the form of a sheet, and the form of a three-dimensional shaped article, and can be flexibly applied to various use forms.

The second feature is that the polymer base material mainly made of a semi-aromatic amide resin having an aliphatic chain in the principal chain thereof is used, and hence the irradiation of the polymer base material with radiation causes radicals in a large amount to be generated exclusively in the aliphatic chain in the principal chain, so that graft side chains of the anionic monomer are introduced to the base material so as to be distributed substantially uniformly to the whole of the base material, and thus a high graft ratio is achieved.

The third feature is that the graft side chains of the anionic monomer are chemically bonded to the aliphatic chain in the principal chain of the semi-aromatic amide resin as a polymer base material and therefore, even when the ion-exchange material is repeatedly used, elimination or dissipation of the graft side chains does not occur, making it possible to maintain the high ionic conduction property.

The fourth feature is that the graft polymer of the anionic monomer having an aromatic structure and a quaternary ammonium structure has a high affinity with the polymer base material mainly made of a semi-aromatic amide resin having an aromatic structure, an amide structure, and an aliphatic chain in the principal chain thereof due to the aromatic structure and amide structure, and therefore, even when the construction of the chemical bonding of the graft polymer to the aliphatic chain deteriorates, elimination or dissipation of the graft polymer is unlikely to occur, making it possible to maintain the high ionic conduction property. The amide structure in the polymer base material has an especially high affinity with the graft polymer of a quaternary ammonium structure having high polarity so that the anionic portion is maintained.

The anionic polymer ion-exchange material of the invention has the above-mentioned features and, for example, preferred properties due to the molecular structure of the anionic polymer ion-exchange material are as follows. For example, the amount of the above-mentioned graft chain is as high as 20 to 100% by weight, based on the weight of the polymer base material, the anionic polymer ion-exchange material has an ion-exchange capacity of 0.8 to 3.0 mmol/g, and has a volume electric conductivity as excellent as 0.01 to 0.20 S/cm, as measured with respect to the material in the state of being saturated with water at room temperature, and the anionic polymer ion-exchange material has a tensile strength as excellent as 25 to 80 MPa.

With respect to the molecular structure of the anionic polymer ion-exchange material of the invention, a characteristic feature can be diagrammatically shown in the formula below.

In the polymer base material, “Polymer principal chain” has an aromatic structure, an amide structure, and an aliphatic chain. “Graft side chain” shown in the formula below branches off from the aliphatic chain in the polymer principal chain, and is formed by graft polymerization of an anionic monomer having an aromatic structure and a quaternary ammonium structure. The benzene ring shown in the formula below is indicated in a simplified form of the “aromatic structure”, and may be any of a monocyclic benzene ring, a heterocyclic structure containing a heteroatom, such as nitrogen, and a polycyclic aromatic structure.

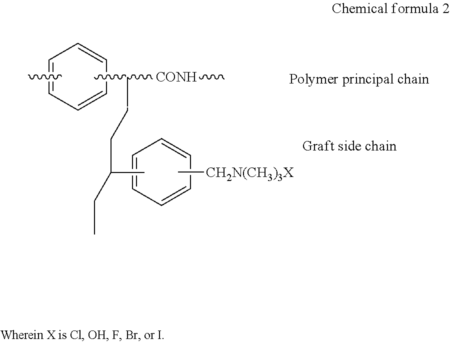

### Polymer Base Material

The polymer base material in the invention is mainly made of an amide resin having an aromatic structure, an amide structure, and an aliphatic chain in the principal chain thereof.

Examples of amide resins include polymers, such as poly(metaxylyleneadipamide), poly(1,3-phenyleneisophthalamide), and poly(1,4-phenyleneterephthalamide), and copolymers and polymer mixture compositions thereof.

Representative examples of amide resins include amide polymers having a structure represented by the chemical formula (1) shown above.

The first repeating unit structure in the chemical formula (1) corresponds to, for example, a polyamide synthesized by a reaction between an aromatic dicarboxylic acid and an aliphatic diamine.

The second repeating unit structure in the chemical formula (1) corresponds to, for example, a polyamide synthesized by a reaction between an aromatic diamine and an aliphatic dicarboxylic acid. The semi-aromatic polyamide constituting the base material used in Examples 1 to 7 described below is obtained by condensation polymerization between metaxylylenediamine, which is a kind of an aromatic diamine, and adipic acid which is a kind of an aliphatic dicarboxylic acid.

The amide resin preferably usable in the invention is not limited to a polymer or copolymer of the above-mentioned semi-aromatic polyamide, and includes a copolymer of the semi-aromatic polyamide with another polymer, such as a nylon polymer, and a resin mixture composition containing the resin.

The term “principal chain” means a principal chain of a polymer comprising amide repeating units.

### Polymer Base Material

When the anionic polymer ion-exchange material is used in the form of a sheet, it is preferred that the polymer base material in a membrane form having a thickness of 10 to 100 μm is used from the viewpoint of obtaining a good balance between production workability, ion-exchange capacity, mechanical strength, assembly workability, and the like.

When the anionic polymer ion-exchange material is used in a fibrous form, it is preferred that the polymer base material in the form of a fiber, a yarn, or the like having a diameter of 1 to 500 μm is used from the viewpoint of obtaining a good balance between production workability, ion-exchange capacity, mechanical strength, assembly workability, and the like.

When the anionic polymer ion-exchange material is used in the form of a three-dimensional shaped article which is pellets, a column, a porous material, a foamed material, or a composite material thereof, it is preferred that the polymer base material is in the form of pellets, a column, a porous material, or a foamed material which is substantially the same form as the final use form of the anionic polymer ion-exchange material. Of course, according to the final application field or use form of the anionic polymer ion-exchange material, the size, thickness, diameter, composite form, or the like of the polymer base material can be appropriately determined based on the experiments and the like irrespective of the above-mentioned ranges of values.

### Anionic Monomer Used in the Graft Polymerization

As examples of the anionic monomers usable in the graft polymerization in the invention, there can be mentioned compounds of the following chemical formula (3).

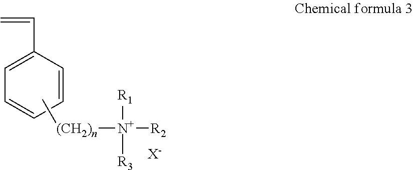

In the formula above, n is an integer of 1, 2, or 3, each of R₁, R₂, and R₃ is a methyl group (CH₃), an ethyl group (C₂H₅), or a propyl group (C₃H₇), and X is Cl, OH, F, Br, or I. Of these, most preferred is the compound of formula (3) wherein n is 1, each of R₁, R₂, and R₃ is a methyl group (CH₃), and X is Cl, i.e., vinylbenzyltrimethyl ammonium chloride.

The compound of formula (3) in which the benzene ring structure portion is polycyclic aromatic or heterocyclic can also be used.

For producing an anionic polymer ion-exchange material having higher stability, it is preferred that a polyfunctional monomer is added in a small amount to the anionic monomer solution. The polyfunctional monomer is also called a crosslinking agent. Examples of crosslinking agents include divinylbenzene (DVB), ethylene glycol dimethacrylate, and methylenebisacrylamide. The amount of the crosslinking agent added is 0.1 to 10% by weight, preferably 0.5 to 5% by weight, based on the total weight of the monomers.

### Method for Producing an Anionic Polymer Ion-Exchange Material

In the method for producing an anionic polymer ion-exchange material of the invention, a graft polymerization method using irradiation with radiation is preferably employed. Among a simultaneous irradiation graft polymerization method and a pre-irradiation graft polymerization method, a pre-irradiation graft polymerization method is further preferably employed. In the pre-irradiation graft polymerization method, a polymer base material is first irradiated with radiation, and the irradiated polymer base material is immersed in an anionic monomer solution to effect a graft polymerization at a predetermined temperature for a predetermined period of time.

More practically, the process described below is preferably employed.

With respect to the type of radiation in the “irradiation with radiation”, a gamma-ray or an electron beam is preferred. With respect to the atmosphere for irradiation, an oxygen-free environment is important. A polymer base material is irradiated in, for example, an atmosphere purged with argon gas, an atmosphere purged with nitrogen gas, or a vacuum vessel. When a polymer base material is irradiated in an atmosphere containing oxygen, there is a concern that the polymer base material suffers deterioration due to oxidation to cause the mechanical strength to lower.

With respect to the irradiation temperature, any appropriate temperature can be used. The irradiation at a low temperature has advantages in that the polymer base material is prevented from suffering deterioration, and in that radicals are unlikely to disappear, thus improving the operating efficiency. On the other hand, from the viewpoint of reduction of the production cost and the like, room temperature is selected as the irradiation temperature.

The exposure dose is a factor which strongly affects the graft polymerization ratio and graft polymerization rate in the subsequent step. The exposure dose in the invention is in the range of from 1 to 500 kGy, preferably 10 to 200 kGy, most preferably 30 to 150 KGy.

In the step of “dissolving an anionic monomer having an aromatic structure and a quaternary ammonium structure in a polar solvent”, preliminary deaeration of the polar solvent for removing oxygen gas is effective. A polar solvent is likely to contain oxygen or moisture having oxygen dissolved therein, and therefore it is preferred that the polar solvent is deaerated for oxygen gas immediately before the production operation so that the solvent contains no oxygen.

The anionic monomer having an aromatic structure and a quaternary ammonium structure is commonly in the state of solid, and must be dissolved in a solvent before subjected to graft polymerization. Examples of solvents include polar solvents, such as water, methanol, and ethanol. Preferred is methanol. Water advantageously dissolves therein the above-mentioned anionic monomer, but water is likely to cause the anionic monomer to undergo homopolymerization, and the use of water alone as a solvent should be avoided.

With respect to the concentration of the graft polymerization solution, there is no particular limitation, but the concentration is generally the anionic monomer saturation concentration or less, and preferably 5% by weight or more. A preferred concentration is 15 to 30% by weight.

In the step in which “the irradiated polymer base material is immersed in the solution of the anionic monomer”, an irradiation vessel containing therein the irradiated polymer base material may be directly filled with the anionic monomer solution. Alternatively, the irradiated polymer base material can be removed from the irradiation vessel and transferred to another vessel for graft polymerization to perform a graft polymerization step. In the latter case, it is important to prevent the irradiated polymer base material from being in contact with oxygen upon removing the irradiated polymer base material from the irradiation vessel.

In the “graft polymerization” in the invention, the polymer base material immersed in the anionic monomer solution is subjected to graft polymerization under predetermined graft polymerization conditions.

Examples of the graft polymerization conditions include a solvent used for dissolving the anionic monomer, a concentration of the graft polymerization solution, a graft polymerization atmosphere, a graft polymerization temperature, and a graft polymerization time.

The graft polymerization atmosphere is an oxygen-free atmosphere. There is a concern that oxygen inhibits the graft polymerization, and therefore it is preferred that the graft polymerization solution is satisfactorily deaerated for oxygen gas.

With respect to the graft polymerization temperature, there is a barter relationship that when the temperature is increased, the grafting rate is increased but the life of radicals is reduced. Therefore, an appropriate graft polymerization temperature is required. Collectively taking into consideration the boiling point of the solvent, the grafting rate, the final graft ratio, and the like, the graft polymerization temperature is generally set in the range of from 30 to 100° C., preferably 40 to 80° C.

The graft polymerization time means a period of time required for achieving a desired graft ratio. Accordingly, the graft polymerization time is associated with the above-mentioned major graft polymerization conditions as well as fine graft polymerization conditions including the construction and operation conditions of a reaction apparatus containing the polymer base material.

It is preferred that the graft polymerization time is controlled to be in the range of from about 0.5 to 48 hours by changing the above-mentioned graft polymerization conditions. The graft polymerization time is more preferably controlled to be 0.5 to 12 hours, most preferably controlled to be 0.5 to 4 hours because a stable graft polymerization can be surely conducted.

After the above-described irradiation step and graft polymerization step are completed, an anionic polymer ion-exchange material having both high mechanical strength and high ionic conductivity, i.e., high ion-exchange capacity is obtained.

Further, if necessary, the obtained polymer ion-exchange material can be subjected to washing step, ion-exchange step, or the like.

### EXAMPLES

Hereinbelow, the present invention will be described with reference to the following Examples and Comparative Example, which should not be construed as limiting the scope of the invention. Examples of preparing an anionic polymer ion-exchange material (membrane) in the form of a sheet from a membrane-form polymer base material are first described. Properties of the obtained polymer ion-exchange material were measured by the methods described below.

### (1) Graft Ratio (%)

When the polymer base material is taken as a principal chain portion and the portion of graft-polymerized anionic monomer is taken as a graft side chain portion, a weight ratio of the graft side chain portion to the principal chain portion is represented as a graft ratio (Xdg [% by weight]) by the following formula.

Xdg=100(W2−W1)/W1

W1: Weight (g) of the polymer base material in a dry state before grafting

W2: Weight (g) of the graft membrane in a dry state after grafting

(2) Ion-Exchange Capacity (mmol/g)

An ion-exchange capacity of the anionic polymer ion-exchange membrane is represented by the following formula.

Ion-exchange capacity (mmol/g)=n/Wd

n: Amount of ammonium group (mmol) in the polymer ion-exchange membrane

Wd: Dry weight (g) of the polymer ion-exchange membrane

n was measured as follows. A polymer ion-exchange membrane was immersed in a 1.0 M aqueous solution of sodium hydroxide at room temperature for 24 hours so that the membrane completely became of a base type (—OH type). Then, the resultant membrane was immersed in pure water for 24 hours, and free ions in the polymer ion-exchange membrane were washed and then, the membrane was immersed in a 3.0 M aqueous solution of sodium chloride at room temperature for 24 hours so that the membrane became of a chlorine type (—Cl type), and an amount of chlorine group was determined by neutralization titration with respect to the exchanged —OH using 0.02 M HCl.

### (3) Water Uptake (%)

An anionic polymer ion-exchange membrane of a —Cl type or —OH type, which has been stored in water at room temperature, is removed from the water and roughly wiped and (after about one minute) a weight of the resultant membrane is taken as Ws (g), and then the membrane is subjected to vacuum drying at 60° C. for 16 hours and a weight of the resultant membrane is taken as dry weight Wd (g), and a water uptake is determined from the following formula.

Water uptake (%)=100(Ws−Wd)/Wd

### (4) Ionic Conductivity (S/cm)

With respect to the ionic conductivity of a polymer ion-exchange membrane, a membrane resistance (Rm) of the membrane in the state of being saturated with water at room temperature was measured by an alternating current method using a cell for general membrane resistance measurement and an LCR meter of HIOKI E. E. CORPORATION. An ionic conductivity of the membrane was determined by making a calculation using the following formula.

Ionic conductivity (S/cm)=d/(Rm*A)

d: Thickness (cm) of the polymer ion-exchange membrane

Rm: Resistance (Q) of the polymer ion-exchange membrane

A: Area (cm²) of the polymer ion-exchange membrane through which an electric current is conducted

### (5) Mechanical Strength

A mechanical strength of the polymer ion-exchange membrane was determined by measuring a tensile strength (MPa) in accordance with JIS K7127 using a dumbbell specimen at a humidity of 50% RH at room temperature (about 25° C.).

### Example 1

A polymer membrane base material (hereinafter, referred to simply as “membrane base material”; thickness: 20 micrometers) made of a semi-aromatic polyamide obtained by condensation polymerization between metaxylylenediamine and adipic acid {corresponding to the formula (1) for repeating units obtained by condensation polymerization between an aromatic diamine and an aliphatic dicarboxylic acid, wherein x is 1 and m is 4} was cut into 10 cm×10 cm, and placed in a separable glass vessel (inner diameter: 3 cmφ×height: 15 cm) having a cock and deaerated, and then argon gas was filled in the vessel so that the membrane base material did not contain any oxygen. The resultant membrane base material in this state was irradiated with a γ-ray at room temperature at an exposure dose of 60 kGy (dose rate: 10 kGy/h). Subsequently, in the glass vessel was placed 80 ml of a methanol solution (concentration: 25 wt %) prepared by dissolving vinylbenzyltrimethyl ammonium chloride (hereinafter, abbreviated to “QB”) in methanol which was a polar solvent, while oxygen gas was deaerated in an oxygen-free atmosphere, and the membrane base material was immersed in the methanol solution. The glass vessel was purged with argon gas and then closed, and a reaction was effected at 60° C. for a grafting time of 24 hours. The obtained graft polymer membrane is an anionic polymer ion-exchange membrane, and the results of the measurement of a graft ratio, an ion-exchange capacity, a water uptake, an ionic conductivity, and a mechanical strength of the membrane are shown in Table 1.

### Example 2

Example 2 is substantially the same as Example 1 except that only the grafting temperature condition was lowered in the treatment. The irradiated membrane base material was immersed in the anionic monomer solution to effect a reaction at 50° C. for a grafting time of 24 hours. The obtained graft polymer membrane is an anionic polymer ion-exchange membrane, and the results of the measurement of properties of the membrane are shown in Table 1.

### Example 3

Example 3 is substantially the same as Example 1 except that only the grafting temperature condition was increased in the treatment. The irradiated membrane base material was immersed in the anionic monomer solution to effect a reaction at 70° C. for a grafting time of 24 hours. The obtained graft polymer membrane is an anionic polymer ion-exchange membrane, and the results of the measurement of properties of the membrane are shown in Table 1.

### Example 4

Example 4 is substantially the same as Example 1 except that only the exposure dose at which the membrane base material was irradiated with a γ-ray at room temperature was reduced in the treatment. The exposure dose was 30 kGy (dose rate: 10 kGy/h). The obtained graft polymer membrane is an anionic polymer ion-exchange membrane, and the results of the measurement of properties of the membrane are shown in Table 1.

### Example 5

Example 5 is substantially the same as Example 1 except that only the exposure dose at which the membrane base material was irradiated with a γ-ray at room temperature was increased in the treatment. The exposure dose was 180 kGy (dose rate: 10 kGy/h). The obtained graft polymer membrane is an anionic polymer ion-exchange membrane, and the results of the measurement of properties of the membrane are shown in Table 1.

### Example 6

Example 6 is substantially the same as Example 1 except that only the temperature at which and the period of time during which the irradiated membrane base material was immersed and kept in the anionic monomer solution to effect a graft reaction were changed in the treatment. A reaction was effected at 60° C. for a grafting time of 6 hours. The obtained graft polymer membrane is an anionic polymer ion-exchange membrane, and the results of the measurement of properties of the membrane are shown in Table 1.

### Example 7

Example 7 is substantially the same as Example 1 except that only the temperature at which and the period of time during which the irradiated membrane base material was immersed and kept in the anionic monomer solution to effect a graft reaction were changed in the treatment. A reaction was effected at 60° C. for a grafting time of 48 hours. The obtained graft polymer membrane is an anionic polymer ion-exchange membrane, and the results of the measurement of properties of the membrane are shown in Table 1.

### Comparative Example 1

A commercially available anionic polymer ion-exchange membrane (trade name: Neosepta ACM membrane) was used, and an ion-exchange capacity, a water uptake, an ionic conductivity, and a mechanical strength of the membrane were determined by the same measurement methods. The results of the measurement are shown in Table 1.

As can be seen from Table 1, in the anionic polymer ion-exchange membranes produced in Examples 1 to 7, by appropriately selecting the graft ratio for the anionic monomer, the properties of the membrane can be controlled in a wide range, specifically, the ion-exchange capacity in the range of from 0.95 to 2.59 mmol/g, the water uptake in the range of from 18.4 to 95.7%, the ionic conductivity in the range of from 0.018 to 0.160 S/cm, and the mechanical strength in the range of from 28.7 to 56.3 MPa, which shows that an ion-exchange material having required properties according to a fuel cell, electrodialysis, water treatment industry, catalyst industry, or the like can be produced. Further, as apparent from a comparison with the Comparative Example, by virtue of the properties of the commercially available anionic polymer ion-exchange membrane in the Comparative Example, an ion-exchange membrane having excellent properties can be produced.

Properties of the anionic polymer ion-exchange membranes in Examples and Comparative Example

TABLE 1

| Measurement | | | | | | | | Comparative |
|---|---|---|---|---|---|---|---|---|
| item | Example 1 | Example 2 | Example 3 | Example 4 | Example 5 | Example 6 | Example 7 | Example 1 |
| Graft ratio (%) | 37.8 | 26.9 | 71.4 | 32.4 | 43.0 | 25.1 | 121.6 | ** |
| Ion-exchange | 1.30 | 1.00 | 1.97 | 1.15 | 1.42 | 0.95 | 2.59 | 1.41 |
| capacity | | | | | | | | |
| (mmol/g) | | | | | | | | |
| Water uptake | 47.0 | 31.5 | 58.7 | 37.0 | 52.1 | 18.4 | 95.7 | 18.6 |
| (%) | | | | | | | | |
| Ionic | 0.072 | 0.018 | 0.112 | 0.046 | 0.082 | 0.015 | 0.160 | 0.004 |
| conductivity | | | | | | | | |
| (S/cm) | | | | | | | | |
| Mechanical | 48.5 | 53.8 | 32.6 | 50.1 | 43.2 | 56.3 | 28.7 | 41.0 |
| strength (MPa) | | | | | | | | |

** The membrane in Comparative Example 1 has no graft structure, and therefore no graft ratio is shown.

### INDUSTRIAL APPLICABILITY

The anionic polymer ion-exchange material of the present invention has higher performance than the currently commercially available anionic polymer ion-exchange materials, and has applicability in a wide variety of fields, such as fuel cells, electrodialysis, water treatment industry, and catalyst industry.

1. An anionic polymer ion-exchange material comprising a polymer base material mainly made of an amide resin having both an aromatic structure and an aliphatic chain in the principal chain thereof, the polymer base material having an anionic monomer graft-polymerized on the aliphatic chain in the principal chain of the amide resin, the anionic monomer having an aromatic structure and a quaternary ammonium structure.

2. The anionic polymer ion-exchange material according to claim 1, wherein the graft polymerization is radiation graft polymerization.

3. The anionic polymer ion-exchange material according to claim 1, wherein the polymer base material mainly made of the amide resin comprises an amide polymer, an amide copolymer, or a composite material mainly made of one or more of the polymers.

4. The anionic polymer ion-exchange material according to claim 1, wherein the anionic monomer does not contain other monomers except a crosslinking agent.

5. The anionic polymer ion-exchange material according to claim 1, wherein the polymer base material is a fibrous base material which is fibers, a yarn, hollow fibers, a rope, or a composite material thereof, and the anionic polymer ion-exchange material is a fibrous material.

6. The anionic polymer ion-exchange material according to claim 1, wherein the polymer base material is a sheet-form base material which is a film, a membrane, woven fabric, nonwoven fabric, or a laminated material thereof, and the anionic polymer ion-exchange material is a sheet-form material.

7. The anionic polymer ion-exchange material according to claim 1, wherein the polymer base material is a three-dimensional shaped base material which is pellets, a column, a porous material, a foamed material, or a composite material thereof, and the anionic polymer ion-exchange material is a three-dimensional shaped material.

8. The anionic polymer ion-exchange material according to claim 1, wherein the amount of the graft polymer chain of the anionic monomer is 20 to 100% by weight, based on the mass of the polymer base material.

9. The anionic polymer ion-exchange material according to claim 1, which has a tensile strength of 25 to 80 MPa.

10. The anionic polymer ion-exchange material according to claim 1, which has an ion-exchange capacity of 0.8 to 3.0 mmol/g, and has a volume electric conductivity of 0.01 to 0.20 S/cm as measured with respect to the material in the state of being saturated with water at room temperature.

11. The anionic polymer ion-exchange material according to claim 1, wherein the amide resin has a principal chain structure represented by the following chemical formula (1):

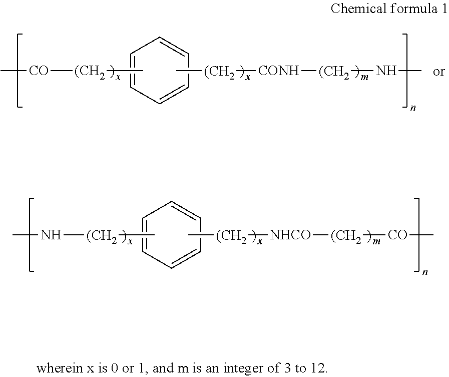

12. A method for producing an anionic polymer ion-exchange material, comprising subjecting to graft polymerization a polymer base material mainly made of an amide resin having both an aromatic structure and an aliphatic chain in the principal chain thereof so that an anionic monomer having an aromatic structure and a quaternary ammonium structure is grafted on the aliphatic chain in the principal chain of the amide resin.

13. The method according to claim 12, which comprises the steps of:
(a) placing a polymer base material mainly made of an amide resin having both an aromatic structure and an aliphatic chain in the principal chain thereof in an apparatus for isolating the inside from an external environment to maintain an oxygen-free atmosphere and allowing the polymer base material to stay in the apparatus for a predetermined period of time or more so that the polymer base material contains no oxygen;
(b) irradiating the polymer base material, which is mainly made of an amide resin having both an aromatic structure and an aliphatic chain in the principal chain thereof and which contains no oxygen, with radiation in an oxygen-free atmosphere;
(c) dissolving an anionic monomer having an aromatic structure and a quaternary ammonium structure in a polar solvent deaerated for oxygen gas in an oxygen-free atmosphere;
(d) conducting a graft polymerization in which the polymer base material irradiated with radiation is immersed in the solution of the anionic monomer in the oxygen-free atmosphere; and
(e) maintaining the irradiated polymer base material in a state of being immersed in the solution of the anionic monomer in the oxygen-free atmosphere to effect the graft polymerization.

14. The method according to claim 13, wherein the oxygen-free atmosphere is an atmosphere purged with argon gas, an atmosphere purged with nitrogen gas, or the inside of a vacuum vessel.

15. The method according to claim 13, wherein the radiation for irradiation is a gamma-ray or an electron beam.

16. The method according to claim 12, wherein the polymer base material is a fibrous base material which is fibers, a yarn, hollow fibers, a rope, or a composite material thereof, and the anionic polymer ion-exchange material is a fibrous material.

17. The method according to claim 12, wherein the polymer base material is a sheet-form base material which is a film, a membrane, woven fabric, nonwoven fabric, or a laminated material thereof, and the anionic polymer ion-exchange material is a sheet-form material.

18. The method according to claim 2, wherein the polymer base material is a three-dimensional shaped base material which is pellets, a column, a porous material, a foamed material, or a composite material thereof, and the anionic polymer ion-exchange material is a three-dimensional shaped material.
